(19) United States
(12) Patent Application Publication
(10) Pub. No.: US 2005/0272901 A1
(43) Pub. Date: Dec. 8, 2005

(54) Process for the preparation of polyurethane prepolymers and/or polyurethane-urea prepolymers

(75) Inventors: Gunter Frauenkron, Burscheid (DE); Herbert Heidingsfeld, Frechen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/143,154

(22) Filed: Jun. 2, 2005

(30) Foreign Application Priority Data
Jun. 7, 2004 (DE) 102004027705.2

(51) Int. Cl. C08G 18/08; C08G 18/16

(52) U.S. Cl. 528/49

(57) ABSTRACT

The present invention provides a process for the preparation of at least one of a polyurethane prepolymer and a polyurethane-urea prepolymer involving mixing in a mixing nozzle at least one diisocyanate with at least one of a polyhydroxyl compound and a polyamino compound having a molecular weight of from about 400 to about 10,000, the mixing nozzle including a first inlet, an annular nozzle channel having a substantially constant diameter, a second inlet and connected through a channel to a dwell line, wherein the first inlet is in communication with the annular nozzle channel through one or more apertures therein, introducing the polyhydroxyl compound and/or polyamino compound into the annular nozzle channel via the second inlet, injecting the diisocyanate through the one or more apertures into the polyhydroxyl compound and/or polyamino compound in the annular nozzle channel and reacting the mixture of diisocyanate and polyhydroxyl compound and/or polyamino compound in the dwell line.

### FIELD OF THE INVENTION

The invention relates to a process for the preparation of polyurethane prepolymers and/or polyurethane-urea prepolymers by mixing at least one diisocyanate and a polyhydroxyl compound and/or polyamino compound in a mixing nozzle.

### BACKGROUND OF THE INVENTION

EP-A 0 554 718 discloses a process for the continuous preparation of polyurethane prepolymers and polyurethane-urea prepolymers by reacting polyisocyanates with polyhydroxyl compounds and/or polyamino compounds, optionally together with monoisocyanates and/or compounds that are monofunctional towards isocyanates, and/or activators, stabilizers, lubricants and other additives known in the art. The isocyanate-containing and hydroxyl-containing and/or amine-containing components are brought together in a nozzle, one of the two components being constricted in the nozzle and the other component being introduced, in the region of this neck, into the stream of the first component in several partial streams through a corresponding number of holes distributed over the periphery of the neck. The components are reacted in a dwell line in the nozzle, downstream from the neck.

The nozzle construction described in EP-A 0 554 718 has proved disadvantageous for long-term operation of the process because blockages of the nozzle holes have regularly led to start-up problems or periods of non-production of the plant, sometimes lasting hours. The blockages require laborious dismantling and cleaning work to be carried out while safety precautions were observed.

### SUMMARY OF THE INVENTION

The present invention, therefore, provides a process for the preparation of polyurethane prepolymers and/or polyurethane-urea prepolymers which does not exhibit the disadvantages known in the art.

These and other advantages and benefits of the present invention will be apparent from the Detailed Description of the Invention herein below.

### BRIEF DESCRIPTION OF THE FIGURE

The present invention will now be described for purposes of illustration and not limitation in conjunction with the FIGURE, wherein:

FIGURE 1 shows an embodiment of a mixing nozzle which may be used for the inventive process.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a process for the preparation of at least one of a polyurethane prepolymer and a polyurethane-urea prepolymer involving mixing in a mixing nozzle at least one diisocyanate with at least one of a polyhydroxyl compound and a polyamino compound having a molecular weight of from about 400 to about 10,000, the mixing nozzle including a first inlet, an annular nozzle channel having a substantially constant diameter, a second inlet and connected through a channel to a dwell line, wherein the first inlet is in communication with the annular nozzle channel through one or more apertures therein, introducing the polyhydroxyl compound and/or polyamino compound into the annular nozzle channel via the second inlet, injecting the diisocyanate through the one or more apertures into the polyhydroxyl compound and/or polyamino compound in the annular nozzle channel and reacting the mixture of diisocyanate and polyhydroxyl compound and/or polyamino compound in the dwell line.

In long-term operation, the nozzle has proved advantageous without a neck in the nozzle channel in the region of the inlet for the diisocyanate, and without a subsequent, i.e. downstream, widening of the nozzle channel. In the process according to the invention, polyurethane prepolymers can be prepared in long-term operation without substantial blockages of the nozzle apertures. Furthermore, the rinsing of the mixing nozzle for cleaning purposes is considerably simplified compared with the nozzles known in the art. The design of the mixing nozzle used in the process according to the invention is appreciably simpler because the nozzle channel has a substantially constant diameter, in contrast to the mixing nozzles known in the art. The diameter is constant particularly in the region where the diisocyanate is injected into the polyhydroxyl and/or polyamino compound. Preferably, the diameter is substantially constant over substantially the entire length of the nozzle channel.

The apertures through which the diisocyanate is injected into the polyhydroxyl and/or polyamino compound are preferably round, but they can also have any other desired geometrical shape. They are arranged in a ring in the wall of the nozzle channel. Adjacent nozzle apertures are arranged in a ring, for example at equal distances or any desired distances from one another. In contrast to the nozzle arrangement in EP-A 0 554 718, where opposite holes are offset relative to one another so that the partial streams are directed past one another, the nozzle apertures are preferably arranged in such a way that pairs of apertures are opposite one another so as to enhance the mixing. Also, the nozzle apertures can be distributed in a ring on several levels, transverse to the direction of flow, it being possible for the apertures on the different levels to be arranged in any desired manner, e.g. offset, relative to one another.

The apertures have a diameter preferably of 0.5 to 10 mm and more preferably of 1 to 2 mm. The number of apertures provided is preferably 2 to 8 and more preferably 4 to 6.

The distance between the inlet for the diisocyanate and the inlet for the polyhydroxyl compound and/or polyamino compound is preferably at most ten times and particularly preferably two to three times the diameter of the nozzle channel.

The length of the nozzle channel is preferably at least ten times the diameter of the nozzle channel.

The flow velocity of the polyhydroxyl compound and/or polyamino compound before injection of the diisocyanate is preferably 1 to 10 ms⁻¹.

Another advantage of the process according to the invention is that the volume flow rates of the diisocyanate and the polyhydroxyl compound can be chosen independently of one another. Preferably, the volume flow rate of the polyhydroxyl compound and/or polyamino compound is greater than that of the diisocyanate, although conversely the volume flow rate of the diisocyanate can be chosen to be greater than that of the polyhydroxyl compound and/or polyamino compound. The process according to the invention also has the advantage that the flow velocity of the polyhydroxyl compound and/or polyamino compound can be chosen to be up to ten times greater than in the process known from the state of the art. A greater flow velocity is desirable because it affords a higher mixing efficiency.

In one embodiment of the process, a high yield is achieved by choosing a performance ratio c_{A}/(i·c_{S}) of 0.002 to 10, the performance ratio being defined as in Equation 1:
c_{A}/(i·c_{S})=(ρ_{A}·V′_{A}·v_{A}²)/i·(ρ_{S}·V′_{S}·v_{S}²) 1
wherein
c_{A} denotes the product stream of the polyhydroxyl compound and/or polyamino compound (subscript A),
c_{S} denotes the product stream of the diisocyanate (subscript S),
ρ denotes the density,
V′ denotes the volume flow rate,
v denotes the flow velocity, and
i denotes the number of partial streams, i.e. the number of nozzle apertures.

Thus, in terms of the present invention, the performance ratio is to be regarded as the ratio of the product of the density, the volume flow rate and the square of the flow velocity of the polyhydroxyl compound and/or polyamino compound to the sum of the partial products of the density, the volume flow rate and the square of the flow velocity of the diisocyanate.

Diisocyanates which may be used for the process according to the invention are the aliphatic, cycloaliphatic, araliphatic, aromatic and heterocyclic diisocyanates known to those skilled in the art. Preferred diisocyanates are aromatic diisocyanates, naphthylene 1,5-diisocyanate, 3,3′-dimethyl-4,4′-diisocyanatobiphenyl (TODI), 1,4-diisocyanatobenzene and the corresponding hydrogenated product, toluylene diisocyanates and diphenylmethane diisocyanate isomers. Particularly preferred diisocyanates are 4,4′-diiso-cyanatodiphenylmethane and its isomers, and an isomeric mixture of 4,4′-diiso-cyanatodiphenylmethane, up to 5 mol %, particularly 1-4 mole %, of 2,4′-diisocyanatodiphenylmethane and small amounts of 2,2′-diisocyanatodiphenyl-methane isomers.

Said diisocyanates can optionally be used together with up to about 15 mole % (based on diisocyanate) of a higher-functional polyisocyanate. However, the amount of higher-functional polyisocyanate must be limited so that, after further processing of the prepolymer to a thermoplastic polymer, the polyurethane elastomer obtained is still fusible or thermoplastic. To prevent an excessive chemical crosslinking of the product, the use of a relatively large amount of higher-functional polyisocyanates must generally be compensated either by partially replacing the polyhydroxyl and/or polyamino compound with one or more monohydroxyl and/or monoamino compounds or by partially replacing the diisocyanate with monoisocyanate. Examples of monoamino compounds which can be used are butylamine or dibutylamine, hydroxylamine, stearylamine and N-methylstearylamine. Examples of possible monohydroxyl compounds are 1-butanol, 2-ethyl-1-hexanol, 1-dodecanol, isobutanol or tert-butanol, cyclohexanol or ethylene glycol monomethyl ether and stearyl alcohol.

Monofunctional compounds such as monoisocyanates, monoalcohols and/or monoamines, in small amounts of e.g. 0.01 to 4 wt. %, based on polyurethane solids, can also be used as chain terminators in a form known to those skilled in the art. Examples of monoalcohols are butanol, 2-ethylenehexanol, isobutyl alcohol, 1-octanol and stearyl alcohol. Examples of monoamines are aniline, dibutylamine, N-methylstearylamine and piperidine.

Preferred polyhydroxyl compounds useful in the process according to the invention are polyesterdiols, polyestercarbonatediols and polyetherdiols, e.g. polyesterdiols made up of linear or branched aliphatic and/or cycloaliphatic diols and aliphatic dicarboxylic acids, especially adipic acid. These can also contain small amounts of aromatic dicarboxylic acids, especially phthalic acid and optionally terephthalic acid, as well as their hydrogenation products. Hydroxypolycarbonates and hydroxypolycaprolactones are also suitable. In one particularly preferred embodiment, 1,4-butanediol adipate of molecular weight 1500 to 5000 is used. It is also preferable to use hydroxyetherdiols based on ethylene oxide, propylene oxide or a mixed polyether of propylene oxide and/or ethylene oxide and/or tetrahydrofuran, e.g. tetrahydrofuran-based hydroxyetherdiols of molecular weight 1000 to 3000. Suitable polyols are described e.g. in DE-A 23 02 564, DE-A 24 23 764, DE-A 25 49 372, DE-A 24 02 840 and DE-A 24 57 387.

Instead of the polyhydroxyl compound, or mixed therewith, it is also possible to use polyamino compounds, preferably with primary aromatic amino compounds. Preferred polyamino compounds are prepared e.g. by the preferably basic hydrolysis of appropriate NCO prepolymers based on higher-molecular polyhydroxyl compounds and excess aromatic diisocyanates. Examples of such processes are described e.g. in DE-A 29 48 419, DE-A 30 39 600 and DE-A 31 12 118. DE-A 29 48 419 also discloses other processes for the preparation of aromatic amino compounds of higher-molecular structure, or so-called aminopolyethers, such as those suitable for the process according to the invention.

Before and/or during and/or after the polyurethane reaction that takes place when the diisocyanate is mixed into the polyhydroxyl compound and/or polyamino compound, it is possible to introduce the conventional additives such as catalysts, release agents, antistatic agents, flame retardants and colorants. The addition of antioxidants and UV absorber is also possible. Examples of catalysts which can be used are tertiary amines and organic metal compounds, especially organic tin, lead and titanium compounds, e.g. tin(II) acetate, tin(II) ethylhexanoate, dibutyltin dilaurate or lead acetate. The release agents used are preferably waxes or oils, long-chain compounds haying carboxyl, ester, amide, urethane or urea groups, and silicones.

The amounts of reactants in the process according to the invention are normally chosen so that the NCO/OH or NCO/NHR ratio of isocyanate to OH compound or amine compound is from 11:1 to 1:1 and preferably from 6:1 to 3:1.

The invention is described in greater detail below with the aid of the attached drawing.

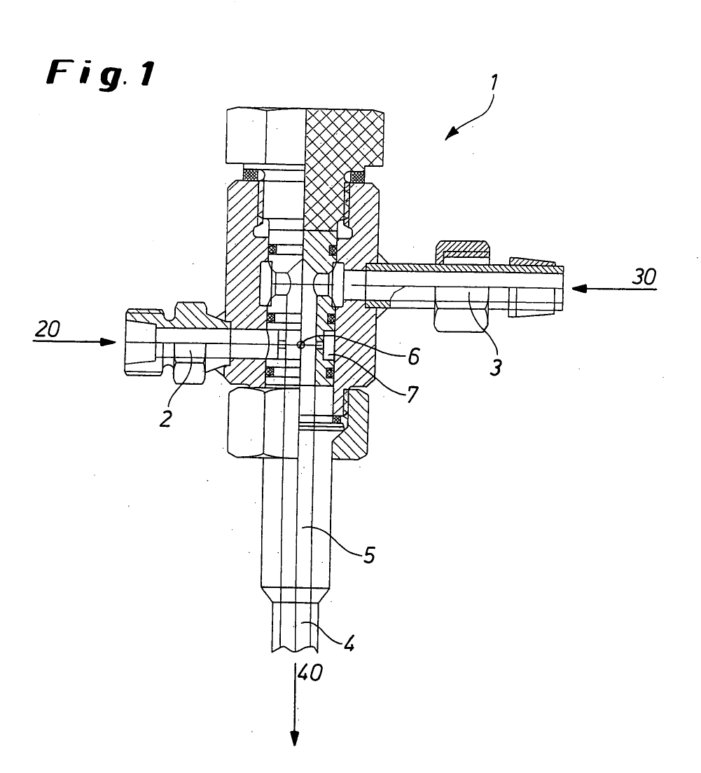

FIG. 1 shows an embodiment of a mixing nozzle such as that which can be used for the process according to the invention. The mixing nozzle 1 has an inlet 3 for the polyhydroxyl compound and/or polyamino compound 30 and an inlet 2 for the diisocyanate 20. In this embodiment, both inlets 2, 3 are arranged substantially perpendicular to the channel 5 of the mixing nozzle 1, the inlet 2 being downstream from the inlet 3. The nozzle channel 5 leads into a dwell line 4, where the two components 20, 30 react to form a prepolymer 40. The diisocyanate 20 is injected into the polyhydroxyl compound and/or polyamino compound 30, for which purpose there is an annular channel 7 in the nozzle channel 5 in the region of the inlet 2. In the region of the annular channel 7, provision is made for several apertures 6 in a ring, through which the diisocyanate 20 flows into the nozzle channel 5, where it mixes with the polyhydroxyl compound and/or polyamino compound 30. In the embodiment shown, the distance between the two inlets 2, 3 is 2.5 times the diameter of the nozzle channel 5.

### EXAMPLES

### Example 1

100 parts by weight of a polyester made from adipic acid and 1,4-butanediol (OH number=50, acid number=0.7), which had been activated with 10 ppm of titanium tetrabutylate, were continuously introduced laterally into the nozzle channel (d=7 mm) through two apertures (d=6 mm). 17 mm further on in the direction of flow, 150 parts by weight of liquid diphenylmethane 4,4′-diisocyanate were continuously introduced laterally into the polyester stream through 8 apertures (d=1.5 mm), mixed by swirling and reacted in the downstream reactor (dwell line). A sample was taken from the resulting reaction product at the end of the reactor and the residual isocyanate was determined by potentiometric titration with dibutylamine solution and alcoholic hydrochloric acid.

Residual NCO content=18.91 wt. %, corresponding to 96.8% conversion to the prepolymer; theoretical NCO content for 100% conversion=18.95 wt. %.

No blockages of the apertures were observed, even in long-term operation.

### Example 2

50 parts by weight of a polyester made up of adipic acid and 1,4-butanediol (OH number=50, acid number=0.7), which had been activated with 10 ppm of titanium tetrabutylate and premixed with 50 parts by weight of a polycarbonatediol made up of diphenyl carbonate and 1,6-hexanediol (MW=2000), were continuously introduced laterally into the nozzle channel (d=7 mm) through two apertures (d=6 mm). 17 mm further on in the direction of flow, 49 parts by weight of liquid diphenylmethane 4,4-diisocyanate were introduced laterally into the polyester stream through 8 apertures (d=1.5 mm), mixed by swirling and reacted in the downstream reactor (dwell line). A sample was taken from the resulting reaction product at the end of the reactor and the residual isocyanate content was determined by potentiometric titration with dibutylamine solution and alcoholic hydrochloric acid.

Residual NCO content=8.64 wt. %, corresponding to 99.8% conversion to the prepolymer; theoretical NCO content for 100% conversion=8.65 wt. %.

No blockages of the apertures were observed, even in long-term operation.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the preparation of at least one of a polyurethane prepolymer and a polyurethane-urea prepolymer comprising:
mixing in a mixing nozzle at least one diisocyanate with at least one of a polyhydroxyl compound and a polyamino compound having a molecular weight of from about 400 to about 10,000, the mixing nozzle comprising
a first inlet,
an annular nozzle channel having a substantially constant diameter,
a second inlet and connected through a channel to a dwell line,
wherein the first inlet is in communication with the annular nozzle channel through one or more apertures therein;
introducing the polyhydroxyl compound and/or polyamino compound into the annular nozzle channel via the second inlet;
injecting the diisocyanate through the one or more apertures into the polyhydroxyl compound and/or polyamino compound in the annular nozzle channel; and
reacting the mixture of diisocyanate and polyhydroxyl compound and/or polyamino compound in the dwell line.

2. The process according to claim 1, wherein the distance between the first inlet and the second inlet is at most about ten times the diameter of the nozzle channel.

3. The process according to claim 1, wherein the length of the nozzle channel is at least about ten times the diameter of the nozzle channel.

4. The process according to claim 1, wherein the polyhydroxyl compound and/or polyamino compound has a flow velocity before injection of the diisocyanate of from about 1 to about 10 ms⁻¹.

5. The process according to claim 1, wherein the ratio of the product of the density, the volume flow rate and the square of the flow velocity of the polyhydroxyl compound and/or polyamino compound to the sum of the partial products of the density, the volume flow rate and the square of the flow velocity of the diisocyanate is from about 0.002 to about 10.

6. The process according to claim 1, wherein the distance between the first inlet and the second inlet is two to three times the diameter of the nozzle channel.

7. The process according to claim 1, wherein the apertures have a diameter of from about 0.5 to about 10 mm.

8. The process according to claim 1, wherein the apertures have a diameter of from about 1 to about 2 mm.

9. The process according to claim 1, wherein the number of apertures is from 2 to 8.

10. The process according to claim 1, wherein the number of apertures is from 4 to 6.
